(19) United States
(12) Patent Application Publication
(10) Pub. No.: US 2016/0122224 A1
(43) Pub. Date: May 5, 2016

(54) AUTOMATED FLOAT GLASS SYSTEM

(71) Applicant: PPG INDUSTRIES OHIO, INC., Cleveland, OH (US)

(72) Inventor: Yu Jiao, Blawnox, PA (US)

(21) Appl. No.: 14/925,156

(22) Filed: Oct. 28, 2015

Related U.S. Application Data
(60) Provisional application No. 62/074,176, filed on Nov. 3, 2014.

(51) Int. Cl. C03B 18/02; C03B 18/10; C03B 18/22; C03B 18/18

(52) U.S. Cl. CPC C03B 18/02; C03B 18/18; C03B 18/10; C03B 18/22

(57) ABSTRACT

A float glass system (10) includes a float bath (14) having an entrance end (26) and an exit end (28). At least one machine vision camera (50, 52, 76, 92) is located to view an interior of the float bath (14). At least one sensor (44, 48, 90, 98) is connected to the float Oath (14) to measure an operating parameter of the float bath (14). At least one operating device (32, 60, 82, 86) is connected to the float bath (14). The at least one machine vision camera (50, 52, 76, 92), the at least one sensor (44, 48, 90, 98), and the at least one operating device (32, 60, 82, 86) are connected to a control system (40) configured to control the operating device (32, 60, 82, 86) based on input from the at least one machine vision camera (50, 52, 76, 92) and/or the at least one sensor (44, 48, 90, 98).

### BACKGROUND OF THE INVENTION

This application claims priority to Provisional Application No. 62/074,176, filed Nov. 3, 2014, which is herein incorporated by reference in its entirety.

### FIELD OF THE INVENTION

This invention relates generally to the manufacture of float glass and, more particularly, to a float glass system having an automated float bath.

### TECHNICAL CONSIDERATIONS

In a float glass process, molten glass from a furnace is poured onto the top of a bath of molten metal located in a float bath. The molten glass forms a continuous glass ribbon. In the float bath, the glass ribbon is sized and cooled. A coating can be applied onto the top surface of the glass ribbon while in the float bath.

In a conventional float bath, multiple pairs of opposed top rollers are used to expand and move the glass ribbon through the float bath. The speed of rotation and the tilt angle of the top rollers affect the width and thickness of the glass ribbon. In a conventional float bath, the top rollers are adjusted manually by operators standing beside the float bath.

Operation of the float bath in a conventional float glass system is one of the most labor intensive processes in the entire float glass manufacturing process. This is particularly true when changes to the glass ribbon thickness and/or width are desired. At such times, the operators at the float bath are required to work in conjunction with a process control supervisor inside a control room to manually adjust each top miler using mechanical handles and levers. This process is labor, time, and cost intensive.

There are also technical problems that must be overcome to adjust the thickness and/or width of the float glass ribbon. For example, synchronizing the individual float bath operators to adjust the position or tilt angle of the top rollers to achieve a desired ribbon width and/or thickness is difficult. Accurately controlling the position or tilt angle of the top roller head is accomplished visually by the operators and, therefore, can vary between operators. Accurately controlling the temperature profile in the float bath, which affects the viscosity of the glass ribbon, is also difficult.

Therefore, it would be advantageous to provide a float glass system and/or method that reduces or eliminates at least some of the technical problems discussed above. For example, it would be desirable to provide a system and/or process in which individual operators were not required to adjust the speed and/or tilt of the top rollers manually. For example, it would be desirable if the position and/or tilt angle of the top roller heads could be adjusted more accurately. For example, it would be desirable if the temperature profile inside the float bath and/or the temperature profile of the glass ribbon could be monitored and/or controlled more accurately. For example, it would be desirable if the change from one width and/or thickness of a glass ribbon to a new width and/or thickness could be accomplished in a less labor intensive manner.

### SUMMARY

A float glass system includes a float bath having an entrance end and an exit end. At least one machine vision camera is located to view an interior of the float bath. At least one sensor is connected to the float bath to measure an operating parameter of the float bath. At least one operating device is connected to the float bath. The at least one machine vision camera, the at least one sensor, and the at least one operating device are connected to a control system configured to control the operating device based on input from the at least one machine vision camera and/or the at least one sensor.

A method of operating a float Mass system comprises providing a float bath having an entrance end and an exit end; locating at least one machine vision camera to view an interior of the float bath; providing at least one sensor connected to the float bath to measure an operating parameter of the float bath; providing at least one operating device connected to the float bath; and connecting the at least one machine vision camera, the at least one sensor, and the at least one operating device to a control system configured to control the at least one operating device based on input from the at least one machine vision camera and/or the at least one sensor.

### BRIEF DESCRIPTION OF THE DRAWINGS

FIG. 1 is a plan view illustrating a float glass system incorporating features of the invention;

FIG. 2 is a side, sectional view of a float bath of FIG. 1 along the line II-II in FIG. 1;

FIG. 3 is a front view of a top roller and optical device of the invention;

FIG. 4 is a side view of the top roller of FIG. 3;

FIG. 5 is a plan view of a top roller illustrating a tilt angle of the top roller head; and

FIG. 6 is a plan view of a top roller and optical device positioned along an edge of a glass ribbon in a float bath.

### DESCRIPTION

Spatial or directional terns used herein, such as “left”, “right”, “above”, “below”, and the like, relate to the invention as it is shown in the drawing figures. It is to be understood that the invention can assume various alternative orientations and, accordingly, such terms are not to be considered as limiting. All numbers used in the specification and claims are to be understood as being modified in all instances by the term “about”. All ranges disclosed herein are to be understood to encompass the beginning and ending range values and any and all subranges subsumed therein. The ranges set forth herein represent the average values over the specified range.

The invention comprises, consists of, or consists essentially of, the following aspects of the invention, in any combination. Various aspects of the invention are illustrated in separate drawing figures. However, it is to be understood that this is simply for ease of illustration and discussion. In the practice of the invention, one or more aspects of the invention shown in one drawing figure can be combined with one or more aspects of the invention shown in one or more of the other drawing figures.

An exemplary float glass system 10 of the invention utilizes one or more machine vision cameras, one or more sensors, or a combination of machine vision cameras and sensors, to automatically or semi-automatically control the operating parameters of a float bath of the float glass system 10. The operating parameters can be controlled to achieve a glass ribbon of a desired thickness and/or width. The components of the float glass system 10 will be described and then operation of the float glass system 10 will be described.

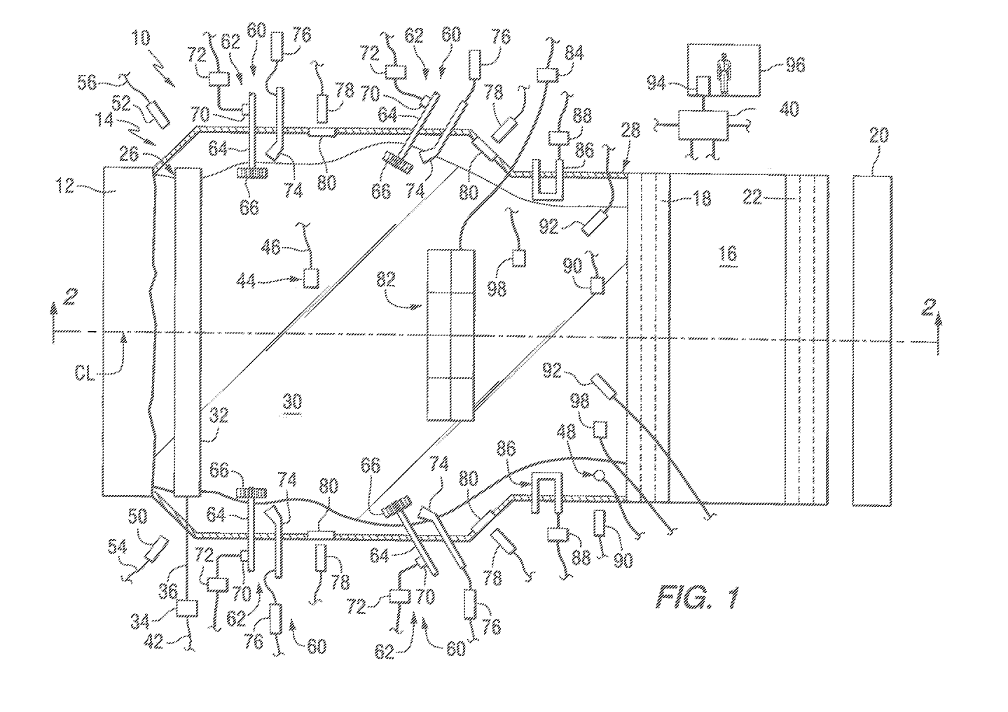

An exemplary float glass system 10 is shown in FIG. 1. The float glass system 10 includes a glass furnace 12 upstream of a float bath 14. The terms “upstream” and “downstream” used herein refer to the direction of movement of the glass ribbon. The float bath 14 is located upstream of a cooling lehr 16. A first conveyor 18 extends between the float bath 14 and the lehr 16. A cutting station 20 is located downstream of the lehr 16. A second conveyor 22 extends between the lehr 16 and the cutting station 20.

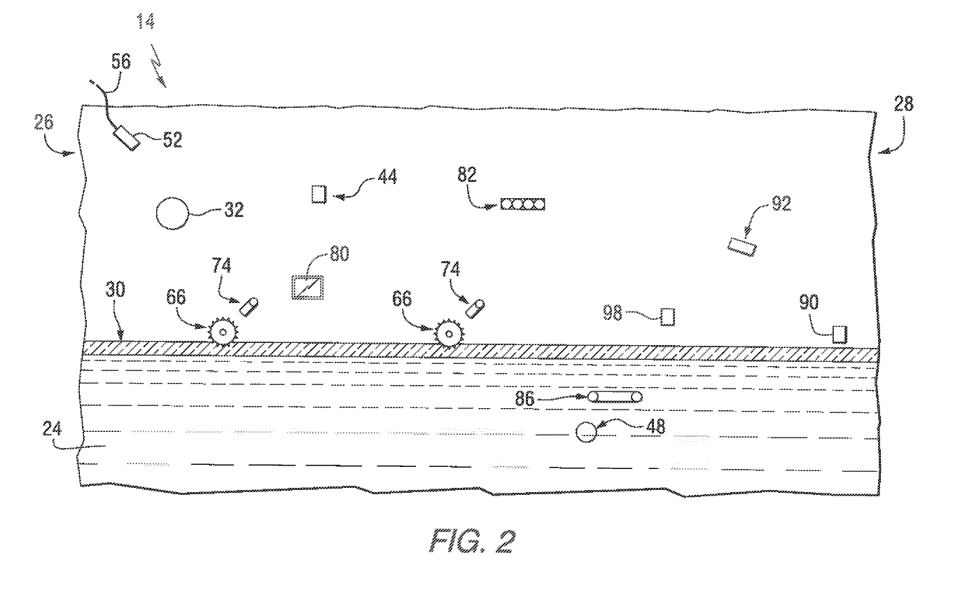

As shown in FIGS. 1 and 2, the float bath 14 includes a pool of molten metal 24, such as molten tin. The float bath 14 has an entrance end 26 adjacent the furnace 12 and an exit end 28 adjacent the first conveyor 18. In the float glass process, molten glass from the furnace 12 is poured onto the top of the molten metal 24 in the float bath 14. The molten glass begins to cool and spreads across the top of the molten metal 24 to form a glass ribbon 30.

At least one first cooler 32, i.e., an entrance cooler, is located downstream of the entrance end 26 of the float bath 14. The first cooler 32 is an overhead cooler. That is, it is located above the pool of molten metal 24. The first cooler 32 is in electronic communication with a cooler control device 34. For example, via a wireless connection or via an electronic cable 36. The cooler control device 34 includes a temperature sensor that senses the temperature of the first cooler 32. The cooler control device 34 can adjust the temperature of the first cooler 32. For example, by increasing or decreasing the flow of cooling fluid to the first cooler 32. The first copier 32 affects the temperature in the headspace of the float bath 14. Decreasing the temperature in the headspace helps to cool the molten glass to increase the viscosity of the molten glass to begin forming the more viscous glass ribbon 30. While only one first cooler 32 is illustrated, it is to be understood that additional such coolers could be located at various locations within the float bath 14.

The cooler control device 34 is in electronic communication with a control system 40. For example, via a wireless connection or via an electronic cable 42. The control system 40 includes a conventional computer with a storage device, such as a hard drive. The control system 40 includes a database of operating parameters for the float bath 14, as discussed below. The database can be an electronic database maintained on a conventional computer system having a conventional memory device and conventional input and output devices. A conventional computer system includes a central processing unit (CPU) in electronic communication with a data storage device, such as a hard drive, optical disk, and the like for storing the database. The CPU may also be in electronic communication with one or more of a read only memory (ROM) which stores CPU program instructions, a random access memory (RAM) for temporary data storage, and a clock for providing time signals to the CPU. The input/output device is connected to the CPU and may be of any conventional type, such as a monitor and keyboard, mouse, touchscreen, printer, voice activated, etc. The computer system runs appropriate custom-designed or conventional software to perform the steps of the invention. The specific hardware, firmware and/or software utilized in the system need not be of a specific type but may be any such conventionally available items designed to perform the method or functions of the present invention. Exemplary computer systems are disclosed in U.S. Pat. Nos. 5,794,207; 5,884,272; 5,797,127; 5,504,674; 5,862,223; and 5,432,904.

At least one air temperature sensor 44 is located in the headspace of the float bath 14 above the molten metal 24. The air temperature sensor 44 is connected to the control system 40. For example, via a wireless connection or by an electronic cable 46. The air temperature sensor 44 monitors the temperature in the headspace of the float bath 14. While only one air temperature sensor 44 is illustrated, it is to be understood that additional such sensors could be located at various locations within the float bath 14.

At least one bath temperature sensor 48 is detects the temperature of the molten metal 24. The bath temperature sensor 48 is connected to the control system 40 in any conventional method. For example, via a wireless connection or by an electronic cable. While only one bath temperature sensor 48 is illustrated, it is to be understood that additional such sensors could be located at various locations within the float bath 14.

At least one machine vision camera is located adjacent the entrance end 26 of the float bath 14. The at least one machine vision camera is part of a machine vision system, as described in more detail below. In the example shown in FIG. 1, a first machine vision camera 50 is positioned to view one lateral side of the interior of the float bath 14 and a second machine vision camera 52 is positioned to view the opposed lateral side of the float bath interior. The machine vision cameras 50, 52 can be located outside of the float bath 14 and aligned with windows in the float bath 14. Or, the first and second machine vision cameras 50, 52 can be located in housings in the float bath 14. The first and second machine vision cameras 50, 52 are positioned to view the glass ribbon 30 at or near the entrance end 26 of the float bath 14. The first camera 50 and second camera 52 are in electronic communication with the control system 40 in any conventional manner. For example, vie wireless connection or by electronic cables 54 and 56. The machine vision software for the machine vision cameras can be stored in the control system 40.

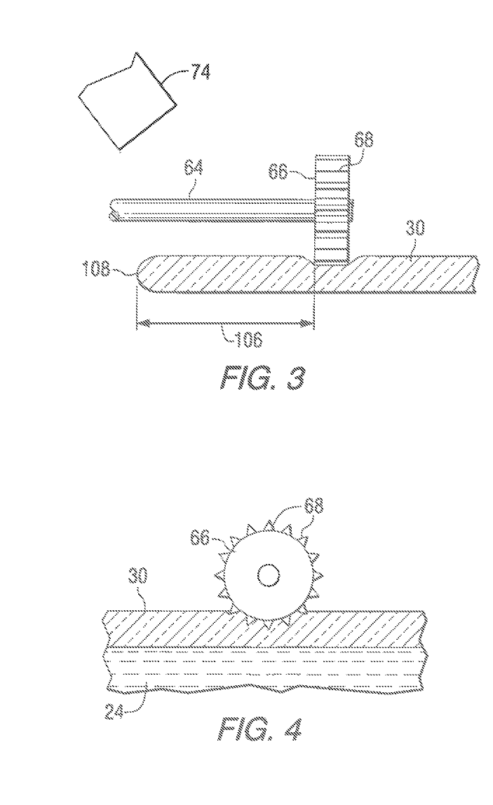

A plurality of opposed sets of roller assemblies 60 are located along the sides of the float bath 14 and extend into the interior of the float bath 14. The roller assemblies 60 include a top roller 62 having a shaft or barrel 64 connected to a rotatable head 66. As shown in FIGS. 3 and 4, the head 66 includes a plurality of circumferential teeth 68 configured to grip the float ribbon 30. Rotation of the roller assembly heads 66 pulls the float ribbon 30 along the top of the molten metal 24. The speed of rotation of the heads 66 affects the thickness of the glass ribbon 30. The faster the speed of rotation, all other parameters remaining the same, the thinner will be the glass ribbon 30. The angle (or tilt) of the heads 66 can affect the width of the glass ribbon 30. For example, angling the heads 66 outwardly increases the width of the glass ribbon 30. Angling the heads 66 inwardly decreases the width of the glass ribbon 30. This angling of the heads 66 also can affect the thickness of the glass ribbon 30. The float bath 14 can include 4 to 10 pairs of opposed roller assemblies 60, for example 5 to 9 pairs, for example 7 pairs. pun The top rollers 62 include a movement device 70, such as a servo mechanism, that controls the speed of rotation of the head 66, the tilt angle of the head 66, and the depth of the head 66 in the glass ribbon 30 (i.e., the bite). The movement device 70 is connected to a controller 72. For example, via a wireless connection or by an electronic cable. The controller 72 is an electronic communication with the control system 40. For example, via a wireless connection or by an electronic cable.

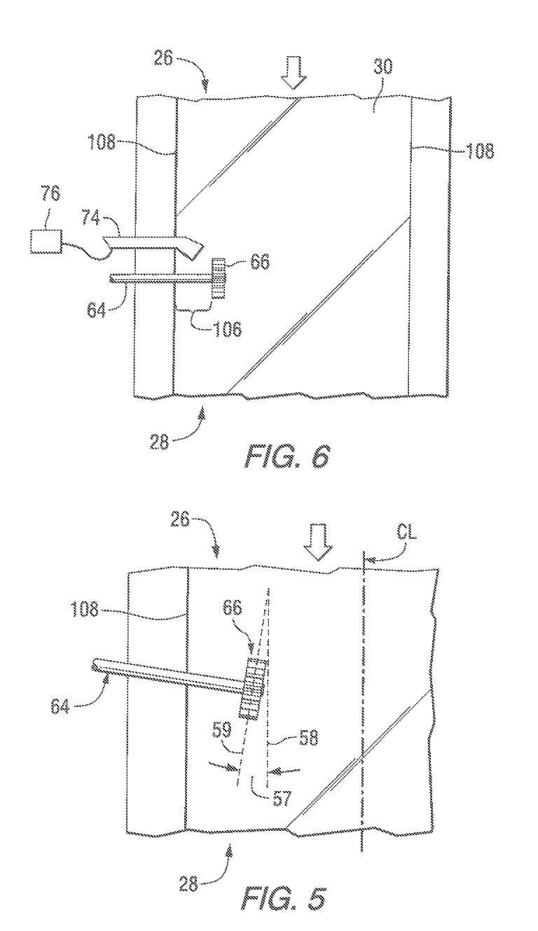

As illustrated in FIG. 5, by “tilt angle” of the roller assembly head 66 is meant the angle 57 formed between a line 58 parallel to a centerline CL of the float bath 14 and a line 59 extending through the head 66 (i.e., indicating the direction the head 66 is pointing). If the head 66 is directed towards the adjacent wall of the float bath 14 (i.e., is pointed outwardly), this stretches and widens the float glass ribbon 30. If the head 66 is directed inwardly (away from the adjacent wall of the float bath 14), this decreases the width of the float glass ribbon 30.

The roller assembly 60 can include an optical device, such as a periscope 74. The periscope 74 extends into the interior of the float bath 14 and is positioned to view the head 66 of the top roller 62. A roller assembly machine vision camera 76 can be positioned to view through the periscope 74. The camera 76 is connected to the control system 40. For example, via a wireless connection or by an electronic cable. As described below, the periscope 74 can also be positioned to view a lateral edge of the float glass ribbon 30.

Alternatively, an exterior machine vision camera 78 can be associated with the roller assembly 60 and can be positioned to view the interior of the float bath 14 through a window 80 in the side of the float bath 14. The exterior camera 78 can be connected to the control assembly 40. For example, via a wireless connection or by an electronic cable. The exterior machine vision camera 78 can be positioned to view a lateral edge of the float glass ribbon 30.

A plurality of heating coils 82 are positioned in the interior of the float bath 14. These heating coils 82 can be attached to the top of the float bath 14 and can extend downwardly above the level of the glass ribbon 30. The heating coils 82 are connected to a control device 84. For example, via a wireless connection or by an electronic cable. The control device 84 senses and controls the temperature of the heating coils 82. The control device 84 is connected to the control system 40. For example, via a wireless connection or by an electronic cable.

A plurality of bath coolers 86 are located in the float bath 14. For example, downstream of the heating coils 82. For example, the coolers 86 can be pipe coolers extending into the molten metal 24. The coolers 86 are connected to a control device 88. For example, via a wireless connection or by an electronic cable. The control device 88 senses and controls the temperature of the coolers 86. The control device 88 is connected to the control system 40. For example, via a wireless connection or by an electronic cable.

At least one thickness sensor 90 is located adjacent the exit end 28 of the float bath 14. The thickness sensor 90 is connected to the control system 40. For example, via a wireless connection or by an electronic cable. The thickness sensor 90 can be, for example, an optical thickness scanner, a machine vision camera, or any conventional thickness measuring device. The thickness sensor 90 measures the thickness of the glass ribbon 30 at or adjacent the exit end 28 of the float bath. The thickness sensor 90 can be located outside of the exit end 28 of the float bath 14. Alternatively, the thickness sensor 90 can be located inside of the float bath 14.

At least one exit machine vision camera 92 is positioned at or adjacent the exit end 28 of the float bath 14. The exit camera 92 is connected to the control system 40. For example, via a wireless connection or by an electronic cable. The exit machine vision camera 92 can be located inside the float bath 14. Alternatively, the exit machine vision camera 92 can be located outside of the exit end 28 of the float bath 14.

A display and input device 94 is located in a control booth 96 and is connected to the control system 40. The display and input device 94 can be a conventional computer monitor and a keyboard.

One or more glass ribbon temperature sensors 98 are positioned in the float bath 14 to measure the temperature of the glass ribbon 30 at various locations. FIGS. 1 and 2 show a glass ribbon temperature sensor 98 positioned adjacent the exit end 28 of the float bath 14. The glass ribbon temperature sensor 98 can be a conventional thermal or optical temperature sensor. The glass ribbon temperature sensor 98 is connected to the control system 40. For example, via a wireless connection or by an electronic cable.

An exemplary operation of the float glass system 10 will now be described.

Molten glass is poured onto the molten metal 24 at the entrance end 26 of the float bath 14. Initial cooling by the first cooler 32 increases the viscosity of the molten glass to form the glass ribbon 30. The top roller heads 66 engage the top of the glass ribbon 30 to move, e.g., pull, the glass ribbon 30 along the top of the molten metal 24 and through the float bath 14. The speed of rotation of the heads 66 affects the speed of the glass ribbon 30 through the float bath. Generally, the higher the speed of rotation of the heads 66, the thinner will be the glass ribbon 30. The tilt angle of the heads 66 affects the width of the ribbon 30 (which can also affect the glass ribbon thickness). If the heads 66 are angled outwardly, this increases the width of the glass ribbon 30 (and can also decrease the thickness of the glass ribbon 30). The barrel position and/or length, head angle, head speed, and bite of the top roller 62 are controlled by the controller 72 connected to the movement device 70 of the roller assembly 60.

The heating coils 82 affect the temperature in the headspace of the float bath 14. The bath coolers 86 affect the temperature of the molten metal 24. These both can affect the viscosity of the glass ribbon 30, which can affect the thickness and/or the width of the glass ribbon 30. Generally, the higher the temperature inside the float bath 14, the thinner and wider will be the glass ribbon 30.

In the past, operating parameters of a conventional float bath were manually set and adjusted by the float bath operators to obtain a desired glass ribbon width and thickness. Examples of these operating parameters include, for example, the barrel position, head angle, head speed of rotation, and bite of the roller assemblies: and/or the temperature in the headspace; and/or the temperature of the molten metal, were manually set and adjusted by the float bath operators to obtain a desired glass ribbon width and thickness.

However, operating parameters of the float bath 14 of the invention can be set or adjusted automatically or semi-automatically. By “automatically” is meant without the need for operator or supervisor approval. By “semi-automatically” is meant that operator or supervisor approval is required before one or more operating parameters of the float bath 14 are changed by the control system 40.

For example, various “recipes” of float bath operating parameters to achieve a desired thickness and/or width of a glass ribbon of a particular composition are stored in the control system 40. For example, these recipes can be stored on the hard drive of the computer. The recipes can be determined, for example, by prior manual settings of the float bath operating parameters determined over time to provide a glass ribbon of a particular width and/or thickness. The control system 40 can also include the machine vision software to provide the image processing for the machine vision cameras associated with the float bath 14. Exemplary machine vision cameras and machine vision software are available from Cognex Corporation, Banner Engineering, and Microscan systems Inc.

Current operating parameters of the float bath 14 are supplied to the control system 40 by the various sensors located in the float bath 14. For example, the temperature in the head space of the float bath 14 at various iodations is supplied by the air temperature sensors 44. The temperature of the glass ribbon 30 at various locations is supplied by the glass ribbon temperature sensors 98. The barrel position, head speed, head angle, and bite are supplied by the controllers 72 of the miler assemblies 60. The temperature of the molten metal 24 is supplied by the bath temperature sensors 48. The thickness of the glass ribbon 30 is supplied by the thickness sensors 90. These operating parameters are automatically updated into the control system 40 by the various sensors. For example, the operating parameters can be updated in the range of every 1 second to 60 seconds, particularly every 1 second to 10 seconds, more particularly every 1 to 2 seconds.

The machine vision cameras can be used to monitor and/or adjust the width and/or thickness of the glass ribbon 30. The first machine vision camera 50 and second machine vision camera 52 provide en image of the lateral edges of the glass ribbon 30 adjacent the entrance end 26 of the float bath 14. These images are supplied to the control system 40 and are processed via the machine vision image processing software to provide a machine vision position of the left and right lateral edges of the glass ribbon 30, which defines a width of the glass ribbon 30 adjacent the entrance end 26 of the float bath 14.

The roller assembly machine vision camera 76 (or the exterior machine vision camera 78) associated with the roller assemblies 60 provides a machine vision location of the lateral edge of the glass ribbon 30 and the distance of the head 66 from the lateral edge of the glass ribbon 30.

The exit cameras 92 provide a machine vision image of the lateral edges of the glass ribbon 30 adjacent the exit end 28 of the float bath 14, which define the width of the glass ribbon 30 adjacent the exit end 28 of the float bath 14.

An operator in the control booth 96 can view or monitor the current operating parameters of the float bath 14 from the data supplied by the various sensors in the float bath 14. The operator can monitor or view the width and/or thickness of the glass ribbon 30 determined from the machine vision system. For example, this data can be displayed on a computer screen.

When it is desired to change the width and/or thickness of the glass ribbon 30, the operating parameters of the float bath 14 to achieve the desired width and/or thickness can be set or adjusted by the operator in the control booth 96 utilizing the control system 40 without the need for manual adjustment by personnel stationed adjacent the float bath 14.

Various recipes (float bath operating parameters to provide a glass ribbon 30 of a predetermined width and/or thickness) or programs are stored in the control system 40. For example, parameters such as head speed, head angle, barrel position, bite, glass temperature, molten metal temperature, and/or headspace temperature, can be stored in the hard drive of the control system 40. These recipes can be determined based on the manual settings of the float bath used in the past to achieve a glass ribbon 30 of a particular width and/or thickness.

The operator can adjust one or more of the operating parameters by inputting new parameters into the control system 40 via the input device 94. These new parameters can be listed in a recipe stored in the control system 40 for a glass composition and selected to provide a glass ribbon 30 having a particular width and/or thickness. The control system 40 then electronically adjusts the float bath operating parameters, for example, head speed, head angle, and headspace temperature, as directed, to change these operating parameters. The operator can monitor the effect of these changes on the thickness and/or width of the glass ribbon 30 by the signals from the thickness scanners 90 and the machine vision exit cameras 92. The operator can make adjustments to one or more of the operating parameters to achieve the desired width and/or thickness.

Alternatively, the width and/or thickness of the glass ribbon 30 can be automatically adjusted or changed by the control system 40. For example, by automatically adjusting the thermal conditions inside the float bath 14 and/or the operating parameters of the roller assemblies 42 to provide a glass ribbon 28 of a predetermined thickness and/or width.

The operating parameters of the float bath 14 are obtained and automatically updated in the computer system 40 via the sensors and machine vision cameras located in and around the float bath 14. For example, the current values of the head speed, head angle, barrel distance into the metal bath, and depth of the head in the glass ribbon (bite), can be transmitted to the control system 40 and stored in a matrix (current values matrix). These current values can be updated frequently, for example, every 1 to 60 seconds, such as every 1 to 10 seconds, such as every 1 to 2 seconds. Thus, the current operating parameters are constantly updated and stored in the control system 40. The width of the glass ribbon 30 at the exit end 28 of the float bath 14 can be provided and updated by the exit machine vision cameras 92 in conjunction with the machine vision software stored on the control system 40.

In order to change the width and/or thickness of the glass ribbon 30, a recipe, i.e., a final target matrix (final values matrix) of the float bath operating parameters to achieve a desired width and/or thickness is selected from the recipes stored in the control system 40. The current values matrix reflects the current operating parameters of the float bath 14. The final values matrix reflects the desired new operating parameters to achieve a glass ribbon of a desired width and/or thickness. To achieve a smooth transition from the current operating parameters to the new final operating parameters, the control system 40 may also include a step change matrix defining the magnitude of changes to specific operating parameters within a specific period of time, and a time parameter to complete the change from the current operating parameters to the new final operating parameters.

Similar current, final, and step change matrices can be developed and stored for other operating parameters of the float bath, such as headspace temperature, bath temperature, etc.

The control system 40 can be programmed such that the change from the current operating parameters to the final operating parameters occurs automatically, e.g., once the operator in the control booth 96 selects a recipe from the storage device of the control system 40 (e.g., using the input device 94), the control system 40 makes the necessary changes in the operating parameters of the float bath 14 without any additional input from the operator. Alternatively, the change can occur semi-automatically, which means that after the desired recipe is selected, the control system requires the operator to input confirmation at one or more points during the change to continue adjusting the float bath operating parameters. Without this input, the control system 40 will not continue changing the operating parameters.

By way of illustration, an exemplary current values matrix (the current operating parameters of the float bath 14) includes a head speed of 20 rotations per minute (rpm), a tilt angle of 20 degrees outward, a barrel distance of 1 meter, a bite of 1 centimeter, and a headspace temperature of 640 degrees Centigrade to provide a glass ribbon 30 having a width of 15 meters and a thickness of 1.8 millimeters (mm). Such a thickness is typical for producing automotive glass.

However, if it is desired to start making architectural glass, for example, having a width of 10 meters and a thickness of 12 mm, the control operator searches the database of the control system 40 for the operating parameters (the final values matrix) to provide the desired width and thickness. For example, assuming the final values matrix is a heed speed of 10 rpm, a tilt angle of 5 degrees inward, a barrel distance of 2 meter, a bite of 1.5 centimeter, and a headspace temperature of 550 degrees Centigrade, in automatic mode, the operator can select the final values matrix. The control system 40 automatically reduces the head speed, decreases the tilt angle, extends the barrel, depresses the head into the glass ribbon, and decreases the headspace temperature (for example, by increasing coolant flow to the coolers 32 and/or reducing the temperature of the heating cons 82). The operator can monitor the change in the operating parameters (as provided by the various in bath sensors) and also the effect on the width of the glass ribbon 30 (via the exit machine vision camera 92) and on the thickness of the glass ribbon 30 (via the thickness sensor 90).

The step change matrix can determine the rate of change of the operating parameters from the current values to the desired final values. For example, the step change matrix can limit the change of one or more operating parameters to not greater than a predetermined amount per unit of time. For example, not snowing a change of greater than 20 percent of the current values matrix (which is continuously updated during the changeover) per 10 minutes. This allows a smooth transition to the new operating parameters.

In addition to width and/or thickness of the glass ribbon 30, the roller assemblies 60 and control system 40 can be used to provide trim control. By “trim control” is meant the width of the glass ribbon 30 outboard of the heads 66. This edge portion of the glass ribbon 30 is typically trimmed off and either recycled or discarded. As shown in FIGS. 3 to 5, the periscope 74 and associated machine vision camera 76 can be used to view the distance 106 from the head 66 to the edge 108 of the glass ribbon 30. This distance 106 can be controlled by the operator in the control booth 96 by adjusting the position of the head 66 with respect to the edge 108 of the glass ribbon 30. Alternatively, this distance 106 can be controlled automatically by the control system 40 by adjusting the position of the head 66 based on the distance 106 determined by the machine vision camera 76 and associated software to achieve a desired trim.

The invention can be described further by the following numbered clauses:

Clause 1: A float glass system 10 comprising a float bath 14 having an entrance end 26 and an exit end 28. The float bath 14 includes at least one glass ribbon thickness sensor 90 to determine a thickness of a glass ribbon 30 and at least one machine vision camera 50, 52, 76, 92 to determine a width of the glass ribbon 30. The at least one thickness sensor 90 and at least one machine vision camera 50, 52, 76, 92 are connected to a control system 40. The control system 40 includes a plurality of float bath operating parameters to obtain a glass ribbon 30 of a desired width and/or thickness.

Clause 2: The float glass system 10 of clause 1, including at least one first cooler 32 located downstream of the entrance end 26 of the float bath 14. The first cooler 32 is operatively connected to the control system 40.

Clause 3: The float glass system 10 of clauses 1 or 2, including at least one air temperature sensor 44 located in the headspaces of the float bath 14 and operatively connected to the control system 40.

Clause 4: The float glass system 10 of any of clauses 1 to 3, including at least one bath temperature sensor 48 located in the float bath and operatively connected to the control system 40.

Clause 5: The float glass system 10 of any of clauses 1 to 4, including at least one machine vision camera located adjacent the entrance end 26 of the float bath 14 and operatively connected to the control system 40.

Clause 6: The float glass system 10 of any of clauses 1 to 5, including a first machine vision camera 50 positioned to view one lateral side of the interior of the float bath 14 and a second machine vision camera 52 positioned to view the opposed lateral side of the float bath interior.

Clause 7: The float glass system 10 of any of clauses 1 to 6, including a plurality of opposed sets of roller assemblies 60 located along the sides of the float bath 14 and extending into the interior of the float bath 14 and operatively connected to the control system 40.

Clause 8: The float glass system 10 of clause 7, wherein the roller assemblies 60 include a top roller 62 having a barrel 64 connected to a rotatable and/or pivotable head 66.

Clause 9: The float glass system 10 of clauses 7 or 8, wherein the roller assemblies 60 include an optical device, such as a periscope 74, extending into the interior of the float bath 14 and positioned to view the head 66 of the top roller 62.

Clause 10: The float glass system 10 of clause 9, including a roller assembly machine vision camera 76 positioned to view through the periscope 74, wherein the roller assembly machine vision camera 76 is operatively connected to the control system 40.

Clause 11: The float glass system 10 of clauses 7 or 8, including an exterior machine vision camera 78 associated with the roller assembly 60 and positioned to view the interior of the float bath 14 through a window 80 in the side of the float bath 14, wherein the exterior camera 78 is operatively connected to the control assembly 40.

Clause 12: The float glass system 10 of any of clauses 1 to 11, including a plurality of heating coils 82 positioned in the interior of the float bath 14, wherein the heating coils 82 are operatively connected to the control system 40.

Clause 13: The float glass system 10 of any of clauses 1 to 12, including at least one bath cooler 86 located in the float bath 14 and operatively connected to the control system 40.

Clause 14: The float glass system 10 of any of clauses 1 to 13, wherein the at least one thickness sensor 90 is located adjacent the exit end 28 of the float bath 14.

Clause 15: The float glass system 10 of any of clauses 1 to 14, including at least one exit machine vision camera 92 positioned at or adjacent the exit end 28 of the float bath 14 and operatively connected to the control system 40.

Clause 16: The float glass system 10 of any of clauses 1 to 15, including a display and input device 94 connected to the control system 40.

Clause 17: The float glass system 10 of any of clauses 1 to 16, including one or more glass ribbon temperature sensors 98 positioned in the float bath 14 end operatively connected to the control system 40.

Clause 18: A method of operating a float bath 14 of a float glass system 10, comprising: storing a plurality of “recipes” of float bath operating parameters to achieve a desired thickness and/or width of a glass ribbon 30 in a control system 40; determining a matrix of current float bath operating parameters (current matrix); selecting a recipe of float bath operating parameters defining a matrix of desired operating parameters to achieve a width and/or thickness of the glass ribbon 30 (final matrix); and adjusting the operating parameters of the float bath 14 to the desired operating parameters.

Clause 19: The method of clause 18, wherein the recipes are determined by prior manual settings of the float bath operating parameters determined to provide a glass ribbon of a particular width and/or thickness.

Clause 20: The method of clauses 18 or 19, wherein the control system 40 includes machine vision software for machine vision cameras associated with the float bath 14.

Clause 21: The method of any of clauses 18 to 20, wherein current operating parameters of the float bath 14 are supplied to the control system 40 by sensors located in the float bath 14.

Clause 22: The method of any of clauses 18 to 21, wherein the operating parameters include at least one of a temperature in the head space of the float bath 14, a temperature of the glass ribbon 30, a barrel position, a head speed, a head angle, and a bite of a roller assembly 60, a temperature of molten metal in the float bath 14, a thickness of the glass ribbon 30, and a width of the glass ribbon.

Clause 23: The method of any of clauses 18 to 22, wherein the operating parameters are automatically updated in the control system 40.

Clause 24: The method of any of clauses 18 to 23, wherein the operating parameters are updated in the range of every 1 second to 60 seconds, particularly every 1 second to 10 seconds, more particularly every 1 to 2 seconds.

Clause 25: The method of any of clauses 18 to 24, including at least one machine vision camera 50, 52, 78, 92 to monitor and/or adjust the width and/or thickness of the glass ribbon 30.

Clause 26: The method of any of clauses 18 to 25, including a first machine vision camera 50 and a second machine vision camera 52 adjacent an entrance end 26 of the float bath 14 to provide a width of the glass ribbon 30 adjacent the entrance end 26 of the float bath 14.

Clause 27: The method of any of clauses 18 to 26, including a roller assembly machine vision camera 76 or an exterior machine vision camera 78 associated with a roller assembly 60 of the float bath 14 to provide a distance of a roller assembly head 66 from a lateral edge of the glass ribbon 30.

Clause 28: The method of any of clauses 18 to 27, including at least one exit camera 92 adjacent the exit end 28 of the float bath 14 to provide the width of the glass ribbon 30 adjacent the exit end 28 of the float bath 14.

Clause 29: The method of any of clauses 18 to 28, including selecting a step change matrix defining the magnitude of changes to specific operating parameters within a specific period of time to adjust from the current operating parameters to the final operating parameters.

Clause 30: The method of any of clauses 18 to 29, wherein the control system 40 changes the operating parameters from the current operating parameters to the final operating parameters once a recipe is selected without additional input from an operator.

Clause 31: The method of any of clauses 18 to 29, wherein after the desired recipe is selected, the control system 40 requires at least one input confirmation to continue adjusting the float bath operating parameters at one or more points during the change.

Clause 32: The method of any of clauses 18 to 31, wherein the control system 40 adjusts the width of the glass ribbon 30 outboard of the heads 66 of the roller assemblies 60 by the machine vision camera 76 and associated software to achieve a desired trim.

It will be readily appreciated by those skilled in the art that modifications, as indicated above, may be made to the invention without departing from the concepts disclosed in the foregoing description. Accordingly, the particular embodiments described in detail herein are illustrative only and are not limiting to the scope of the invention, which is to be given the fug breadth of the appended claims and any and all equivalents thereof.

The invention claimed is:

1. A float glass system, comprising:
a float bath having an entrance end and an exit end;
at least one machine vision camera located to view an interior of the float bath;
at least one sensor connected to the float bath to measure an operating parameter of the float bath;
at least one operating device connected to the float bath; and
a control system, wherein the at least one machine vision camera, the at least one sensor, and the at least one operating device are operatively connected to the control system, and wherein the control system controls the at least one operating device based on input from the at least one machine vision camera and/or the at least one sensor.

2. The system of claim 1, including at least one first machine vision camera located adjacent the entrance end of the float bath.

3. The system of claim 1, including at least one second machine vision camera located adjacent the exit end of the float bath.

4. The system of claim 1, further comprising:
at least one roller assembly comprising a barrel and a head extending into an interior of the float bath;
a periscope positioned to view the head of the roller assembly; and
a third machine vision camera operatively connected to the periscope.

5. The system of claim 1, wherein the control system includes a plurality of sets of predetermined operating parameters to provide a glass ribbon having a desired width and and/or thickness.

6. The system of claim 5, wherein the control system includes a current matrix of operating parameters, a desired final matrix of operating parameters, and optionally a step change matrix of operating parameters.

7. The system of claim 1, including first cooler located adjacent the entrance end of the float bath and connected to the control system.

8. The system of claim 1, including at least one air temperature sensor located in the float bath and connected to the control system.

9. The system of claim 1, including at least one bath temperature sensor located in the float bath and connected to the control system.

10. The system of claim 1, including a set of heating coils located in the float bath and connected to the control system.

11. The system of claim 1, including a glass ribbon temperature sensor located in the float bath and connected to the control system.

12. The system of claim 1, including at least one glass ribbon thickness sensor located in the float bath and connected to the control system.

13. The system of claim 1, including an input device connected to the control system.

14. The system of claim 1, wherein the control system includes machine vision software.

15. A method of operating a float glass system, comprising:
providing a float bath having an entrance end and an exit end;
locating at least one machine vision camera to view an interior of the float bath;
providing at least one sensor connected to the float bath to measure an operating parameter of the float bath;
providing at least one operating device connected to the float bath; and
connecting the at least one machine vision camera, the at least one sensor, and the at least one operating device to a control system configured to control the at least one operating device based on input from the at least one machine vision camera and the at least one sensor.

16. The method of claim 15, further comprising:
storing a plurality of recipes of float bath operating parameters to achieve a desired thickness and/or width of a glass ribbon in the control system;
determining a current matrix of current float bath operating parameters;
selecting a recipe of final float bath operating parameters defining a final matrix of desired operating parameters to achieve a width and/or thickness of a glass ribbon, and
adjusting the operating parameters of the float bath to the desire^{,}1 final matrix of operating parameters.

17. The method of claim 16, wherein the recipes are determined by prior manual settings of the float bath operating parameters determined to provide a glass ribbon of a particular width and/or thickness.

18. The method of claim 16, including selecting a step change matrix defining a magnitude of changes to specific operating parameters within a specific period of time to adjust from the current operating parameters to the final operating parameters.

19. The method of claim 16, wherein the control system changes the operating parameters from the current operating parameters to the final operating parameters once a recipe is selected without additional input.

20. The method of claim 16, wherein after the desired final matrix is selected, the control system requires at least one input confirmation to continue adjusting the float hath operating parameters.
